(19) United States
(12) Patent Application Publication
(10) Pub. No.: US 2024/0077714 A1
(43) Pub. Date: Mar. 7, 2024

(54) MICROSCOPY SYSTEM AND METHOD FOR OPERATING A MICROSCOPY SYSTEM

(71) Applicant: Carl Zeiss Meditec AG, Jena (DE)

(72) Inventors: Andreas Raab, Oberkochen (DE); Jonathan Essig, Oberkochen (DE); Stefan Ernsperger, Oberkochen (DE); Natalie Krieg, Oberkochen (DE); Andrè Müller, Oberkochen (DE)

(21) Appl. No.: 18/387,833

(22) Filed: Nov. 7, 2023

Related U.S. Application Data
(63) Continuation of application No. PCT/EP2022/062305, filed on May 6, 2022.

(30) Foreign Application Priority Data
May 7, 2021 (EP) 21 172 758.1

(51) Int. Cl. G02B 21/36; G06T 7/70; G06V 10/141; G06V 10/143

(52) U.S. Cl. CPC G02B 21/365; G06T 7/70; G06V 10/141; G06V 10/143; G06T 2207/10056

(57) ABSTRACT

A microscopy system includes a tracking camera for pose detection of a marker, a device configured to determine a working distance, a movable optical element, the pose of which can be changed to set a capture region of the tracking camera and/or at least two tracking illumination devices, at least one optical element for beam guidance of the radiation generated by the tracking illumination devices, and a controller configured to control the movable optical element and/or the tracking illumination devices, in which the pose of the movable optical element can be set based on the working distance and/or in which an operating mode and/or an illumination region of the tracking illumination devices can be set based on the working distance. In addition, a method for operating a microscopy system is provided.

### CROSS REFERENCE TO RELATED APPLICATIONS

This application is a continuation application of international patent application PCT/EP2022/062305, filed May 6, 2022, designating the United States, and claiming priority to European Patent application EP 21 172 758.1, filed May 7, 2021, and the entire content of both applications is incorporated herein by reference.

### TECHNICAL FIELD

The disclosure relates to a microscopy system and to a method for operating a microscopy system.

### BACKGROUND

The prior art describes microscopy systems for providing a magnified view of examination objects, in particular in medical applications. Such microscopy systems may be surgical microscopes. They serve, among other things, to provide a magnified view of subregions of a body, in order to give a surgeon better visual orientation during an intervention. Surgical microscopes are generally mounted in a movable manner, in particular on a stand. Among other things, this allows a user to change a pose, that is to say a position and/or orientation, of the microscope, for example in order to modify a viewing angle onto an examination region or in order to view other examination regions.

DE 10 2018 206 406 B3 describes a microscopy system having a pose detection device for detecting a spatial pose of a target, wherein the pose detection device includes the at least one target having at least one marker element and an image capture device for optical detection of the target. Furthermore, the document states that the microscopy system may include an illumination device for illuminating the target. The described pose detection device may be used to detect the pose of an instrument, for example a medical instrument, when the target is attached to the instrument. Such pose detection may be desirable if for example a current pose of the instrument relative to preoperatively generated data, such as for example Magnetic Resonance Imaging (MM) or Computed Tomography (CT) volume data, is intended to be displayed.

U.S. Pat. No. 9,827,054 B2 is also known. This document describes the mechanically assisted positioning of medical instruments during medical applications. A microscope and pose detection are also described.

DE 10 2018 206 406 B3 describes a microscopy system and a method for operating the microscopy system.

US 2009/213457 A1 relates to the field of light microscopy and to an illumination device for a microscope having a variable working distance, in which the illumination light is directed onto the object obliquely to the objective (oblique illumination).

US 2004/136190 A1 describes an illumination arrangement for illuminating a measurement object, in particular intended for a coordinate-measuring device or a measuring microscope, including multiple light sources that extend from a carrier and have different angles of incidence with respect to an optical axis of an optical unit with which the object is able to be measured or imaged.

US 2019/046041 A1 describes a fluorescence navigation system for performing fluorescence navigation surgery as an operation, to an image-processing system used for this purpose, to an image-processing method, to an information-processing program and to a fluorescence observation system.

One issue with pose detection with an optical pose detection device, in particular when detecting a target or markers of a target in an image representation, is that a capture region of a tracking camera (that is to say of the image capture device for pose detection) is small at very short working distances, meaning that a target may be moved easily out of the capture region, and reliable pose detection is then no longer possible. There may also be the issue that a resolution of the imaged target or marker is too low, namely when a working distance is too large. It is also problematic that, in current systems, the generated image representation may be underexposed at high working distances or overexposed at short distances. Both effects undesirably influence the quality of the pose detection. These effects may lead in particular to inaccurate and thus unreliable pose detection or to pose detection not being able to be performed.

Also known are microscope-external pose detection devices, which are arranged for example as separate systems in an operating room. Mention is made, by way of example, of the optical pose detection device from NDI (Northern Digital Inc.) known as Polaris Vega VT. Such detection devices require extra installation space in the operating room. Another issue with such pose detection devices is masking, for example when a user moves between a target and the image capture devices of such a pose detection device. This restricts the range of movement of medical staff. The pose detection using such a pose detection device likewise regularly requires a target having at least one marker also to be arranged on the surgical microscope to provide desired functionalities. The attachment of additional targets to the surgical microscope generally also requires such targets to be disassembled during maintenance, these then being reassembled after maintenance and necessitating recalibration of the pose detection device. Furthermore, such microscope-external pose detection devices require strong illumination, namely to illuminate regions in the operating room so that all of the targets of interest, which are arranged for example on the patient, on an instrument and on the microscopy system, are able to be imaged reliably. Such systems likewise require high-resolution image capture devices and high computing powers to evaluate the image representations necessary for the pose detection.

Another disadvantage with such pose detection devices is increasing inaccuracy at large distances between a target and the image capture devices.

### SUMMARY

It is therefore an object of the disclosure to provide a microscopy system and a method for operating this microscopy system, both of which enable reliable and accurate pose detection carried out with reduced installation space requirements.

The object is achieved by a microscopy system and a method for operating a microscopy system as described herein.

The microscopy system includes a microscope. Within the meaning of this disclosure, a microscope designates a device for providing a magnified visual representation of an examination object. The microscope may be a conventional light microscope, which generates an enlarged image representation by utilizing optical effects, in particular with beam guidance and/or beam shaping and/or beam deflection, for example lens elements. However, the microscope may also be a digital microscope, wherein the image representation to be visualized by the microscope may be produced by way of an image capture device and may be displayed on an appropriate display device, for example a display unit.

The microscope may in particular include at least one eyepiece. The eyepiece refers to a part of the microscope through which or into which a user looks to view the image representation produced by the microscope. In other words, an eyepiece forms an eye-side optical interface of the microscope. The eyepiece may form part of a tube. Furthermore, the microscope may include at least one objective or objective system. This objective may produce a real optical image representation of an examination object. The objective may in this case include optical elements for beam guidance and/or beam shaping and/or beam deflection. The eyepiece may be optically connected to the objective.

Moreover, the microscope may include a microscope body. The microscope body may have or form a beam path for microscopic imaging. The microscope body may in this case include further optical elements for beam guidance and/or beam shaping and/or beam deflection. The objective may be integrated into the microscope body or be attached thereto, in particular releasably. The objective may in this case be arranged in a fixed position relative to the microscope body. Moreover, the microscope body may have or form at least one attachment interface for attaching, in particular releasably attaching, a tube. The microscope body may include or form a housing or be arranged in a housing.

Furthermore, the microscopy system may include a stand for holding the microscope. The microscope, in particular the microscope body, may consequently be mechanically fastened to the stand. The stand is configured here such that it allows a movement of the microscope in space, in particular with at least one degree of freedom, typically with six degrees of freedom, wherein a degree of freedom may be a translational or a rotational degree of freedom. The degrees of freedom in this instance may relate to a reference coordinate system. A vertical axis (z-axis) of this reference coordinate system may be oriented parallel to gravitational force and counter thereto. A longitudinal axis (x-axis) of the reference coordinate system and a transverse axis (y-axis) of the reference coordinate system may in this instance span a plane oriented perpendicular to the vertical axis. Moreover, the longitudinal axis and the transverse axis may also be oriented orthogonal to one another.

Moreover, the stand may include at least one drive device for moving the microscope. Such a drive device may be a servo motor, for example. Of course, the stand may also include means for transmitting forces/moments, for example gear units. In particular, it is possible for the at least one drive device to be driven such that the microscope carries out a desired movement and thus a desired change in pose in space or adopts a desired pose, that is to say a position and/or orientation, in space. For example, the at least one drive device may be driven such that an optical axis of the objective adopts a desired orientation. Moreover, the at least one drive device may be driven such that a reference point of the microscope, for example a focal point, is positioned at a desired position in space. A target pose in this instance may be specified by a user or by another superordinate system. Methods for controlling the at least one drive device based on a target pose and a kinematic structure of the stand are known here to a person skilled in the art.

The microscopy system includes a tracking camera for imaging at least one marker. This tracking camera may be part of a pose detection device of the microscopy system. The pose detection device may furthermore include an evaluation or computing device, which may perform pose determination/detection by evaluating the image representations generated by the tracking camera. The marker or the marker element may in this case be part of a target or be attached to a target. The target or the marker may be attached to a (medical) instrument. The tracking camera includes an image sensor, such as a charge-coupled device (CCD) or complementary metal-oxide-semiconductor (CMOS) image sensor. For example, a resolution of the image sensor may be 12 megapixels. The tracking camera may furthermore include an optical system having at least one optical element. The pose detection may also be used for pose tracking, that is to say determining the pose at multiple successive points in time. The tracking camera may be used to perform in particular what is known as monoscopic pose detection. In this case, the pose may be determined by evaluating a two-dimensional image representation, in particular exactly one two-dimensional image representation. The tracking camera may be part of a pose detection device that may also include, in addition to the tracking camera, an evaluation device for determining the pose in a predetermined reference coordinate system. The pose refers to a spatial position and/or a spatial orientation in the reference coordinate system. In particular, an evaluation of intensity values of pixels of the two-dimensional image representation may be performed in order to determine the pose. Such methods for image-based pose detection using exactly one tracking camera or multiple tracking cameras are known to a person skilled in the art.

According to an aspect of the disclosure, the microscopy system includes at least one device for determining a working distance of the microscope. This working distance of the microscope may denote a distance between a plane of focus and a terminating element of an objective system of the microscope along an optical axis of the microscope, which may be defined by the objective or objective system of the microscope. The terminating element may be for example a lens (front lens) of the objective/objective system or a transparent terminating plate. The plane of focus or detection plane may designate a plane in the object space, wherein an object in this plane is imaged with a desired sharpness. Said plane may be oriented orthogonal to the optical axis of the microscope that intersects the plane of focus at the center of the depth-of-field range. The depth-of-field range is dependent in a known manner on a currently set focal length, the currently set distance, and also the currently set aperture. It is thus possible in particular to determine the plane of focus and thus also the working distance on the basis of at least one of said variables. Of course, other methods for determining the working distance are also conceivable. For example, it is possible that a working distance of the microscope may be set to one or more, but not all, values of a predetermined value range, for example to the value 100 mm, the value 200 mm and the value 630 mm.

The working distance of the microscope may be determined automatically using methods known to a person skilled in the art. Thus, the working distance may be determined when a pose a plane of focus of the microscope has been set by a user or by performing an autofocus function, in other words, i.e., a focused state of the microscope is set. The focusing is carried out by setting parameters of the objective of the microscope, for example a pose of at least one movable optical element of this objective.

The autofocus function may be performed for example by a focusing device of the microscopy system. In this state, a working distance may then be determined based on the set parameters of the objective, for example via a predetermined assignment, a predetermined characteristic curve or a predetermined function, in particular a polynomial function. For example, an image distance of an objective of the microscope may be set during focusing, wherein a working distance may be assigned to this image distance, or a working distance may be determined from a set image distance. For example, it may thus be assumed that a distance of a marker, in particular if the latter is arranged at an instrument, from the tracking camera of the microscopy system corresponds exactly or approximately to the working distance of the microscope, in particular because a surgeon for example also uses/moves the instrument with such a marker generally in the region that is sharply imaged by the microscope.

It is also possible that the microscopy system includes a device for determining a working distance of the tracking camera, wherein this working distance is typically, but not absolutely necessarily, determined based on the working distance of the microscope, for example via a previously known assignment. The assignment allows the working distance of the tracking camera to be assigned to a working distance or a working distance range of the microscope. The working distance of the tracking camera may denote a distance between a plane of focus and a terminating element, for example a (front) lens of an objective system of the tracking camera along an optical axis of the tracking camera, which may be defined by the objective or objective system of the tracking camera. However, it is also conceivable to determine the working distance of the tracking camera independently of the working distance of the microscope.

Furthermore, the microscopy system includes at least one movable optical element, the pose of which may be changed in order to set a capture region of the tracking camera. The movable optical element may be part of the objective system of the tracking camera. In particular, a viewing angle of the tracking camera may be changed by way of the change in pose. The capture region may in this case be conical, for example. The pose of a focal point of the optical element or of an objective system comprising the optical element may also be changed by moving the optical element. Furthermore, the microscopy system includes at least one control device for controlling the movable optical element, in particular for motion control. This control device makes it possible in particular to control a movement of the movable optical element into a desired pose.

Furthermore, the pose of the movable optical element can be set based on the working distance. For example, different poses of the movable optical element may each be assigned to different working distances or different working distance ranges, wherein, for a working distance, the pose that is assigned to this working distance, or the region in which the working distance is located, is set. For example, the assignment of a working distance to a pose may be determined using a calibration method. It is also conceivable for there to be a functional relationship between the pose and the working distance, wherein the pose may then be established by evaluating the relationship. The different poses of the movable optical element that can be set define different capture regions, in particular capture regions with differing capture angles. Thus, these poses also define different planes of focus of the tracking camera.

As an alternative, but typically in addition to the movable optical element, the microscopy system includes at least two tracking illumination devices and at least one optical element configured as a lens element for beam guidance of the radiation generated by the tracking illumination devices. The at least one optical element may thus be used to define an illumination region. Such an illumination device may be configured as an LED. A tracking illumination device may in this case generate light in the near-infrared region, typically in a narrowband wavelength range, for example at a wavelength of 850 nm or at a wavelength from a range of 800 nm to 900 nm. In such an exemplary embodiment, the at least one marker may be formed at least partially or completely from a material that reflects this radiation.

If the microscopy system includes a tracking illumination device, then the control device may be used, as an alternative or in addition, to control an operating mode, in particular an activation state and/or an intensity of the generated radiation, and/or to set an illumination region of the tracking illumination device. One activation state may in this case be “not active”, for example, wherein no radiation is generated by the tracking illumination device in this state. Another activation state may be “active”, wherein radiation is generated by the tracking illumination device in this activation state. The intensity may also be set in the active state. To set an illumination region, an illumination angle, a size and/or a geometric shape of the illumination region may be set, for example by actuating (optical) elements to set said quantities. It is possible for example for an optical element for beam guidance of the radiation generated by a tracking illumination device to be a movable and/or deformable optical element, wherein a pose and/or a shape of this optical element may be changed to set different illumination regions. This optical element may be an element configured to correspond to the movable optical element for setting the capture region of the tracking camera. The illumination angle may be a radiation angle of the illumination device. This may in turn correspond to the aperture angle of a conical illumination region.

If the microscopy system includes a tracking illumination device, then, as an alternative or in addition to setting the pose of the movable optical element, an operating mode of the one or more tracking illumination devices can be set based on the working distance. It is possible for different operating modes of the one or more tracking illumination devices to be assigned to different working distances or ranges, wherein the operating mode of the tracking illumination devices is then set by the control device that is assigned to the currently determined working distance or range. Different operating modes may in this case differ in terms of a number of activated tracking illumination devices and/or in terms of the intensity of the radiation generated by at least one activated tracking illumination device. As a further alternative or in addition, the illumination region may also be able to be set based on the working distance, in particular by setting the mode of operation of the tracking illumination devices, but also by actuating other elements for the purpose of influencing the illumination region.

The provided microscopy system advantageously enables accurate and reliable pose detection of a marker by the tracking camera, requiring little installation space. The capture region may thus be adapted to different distances between marker/target and tracking camera, as a result of which in particular the risk of unwanted removal of the marker from the capture region of the tracking camera, that is to say a loss of vision, is minimized, which in turn increases the reliability of the pose detection. A large capture angle of the tracking camera may be set for short working distances and a smaller capture angle may be set for larger working distances. By way of example, it may thus be assumed that, at a set working distance of the microscope, a target or marker is arranged in a predetermined spatial region along the optical axis of the microscope in front of and/or behind a working distance plane that intersects the optical axis, in particular orthogonally. It may thus in particular be assumed that a user focuses the microscope on an operating region and that markers/targets are moved in a spatial region around this operating region, for example because an instrument having a marker is used in this spatial region or a patient to whom a marker is attached is arranged in this spatial region. The movement of the optical element thus makes it possible to set the capture region of the tracking camera such that a target/marker arranged in this spatial region can be imaged reliably and with a quality desired for the pose detection.

The working distance-dependent setting of the operating mode of the tracking illumination devices likewise makes it possible to improve the reliability and accuracy of the pose detection; in particular, the problems of overexposure or underexposure for different working distances mentioned at the outset may be reduced. By way of example, an overall intensity of the generated radiation may be set lower for lower working distances than for comparatively larger working distances. The integration of the tracking camera and of the illumination devices into the microscopy system gives rise to the explained design requiring little installation space.

In one exemplary embodiment in which the microscopy system includes a movable optical element for setting the capture region, the microscopy system may include exactly one tracking illumination device. In one exemplary embodiment in which the microscopy system includes at least two tracking illumination devices, it is possible that a capture region of the tracking camera is not changeable, for example when an objective system of the tracking camera is configured as a fixed focal length objective system.

In a further exemplary embodiment, a first capture angle of the tracking camera is set for a first working distance and a further capture angle of the tracking camera is set for at least one further working distance, with the first working distance being less than the further working distance and the first capture angle being larger than the further capture angle. The capture angle may in this case designate a viewing angle of the tracking camera, in particular a horizontal viewing angle, vertical viewing angle or diagonal viewing angle. The dimension of an intersection of the capture region with a plane that intersects the optical axis of the tracking camera at the first working distance, for example intersects it orthogonally, may thus be larger for the first detection angle than for the further detection angle. This however in turn ensures that markers that are spaced from the terminating element of the tracking camera by the further working distance are also able to be captured with a sufficiently high resolution.

In a further exemplary embodiment, a plurality of the activated tracking illumination devices and/or an intensity of the activated tracking illumination devices is able to be set on the basis of the working distance. This makes it possible to be able to set in particular an overall intensity of the radiation generated by the tracking illumination devices. The setting may in this case—as explained above—take place in an assignment-based manner, wherein different numbers of activated tracking illumination devices and/or different intensities of the activated tracking illumination devices are assigned to the different working distances and are set when a corresponding working distance has been determined as being current. This advantageously results in the illumination being adapted to the working distance, whereby in particular overexposures at short working distances and underexposures at comparatively long working distances can be avoided.

In a further exemplary embodiment, a first overall intensity of the radiation generated by the tracking illumination devices is set for a first working distance. Furthermore, a further overall intensity of the radiation generated by the tracking illumination devices is set for a further working distance, with the first working distance being less than the further working distance and the first overall intensity being lower than the further overall intensity. As explained, it is possible to set the overall intensity by setting the number of activated illumination devices and/or by setting the intensity of the activated illumination devices. However, it may be the case that an activation state of the tracking illumination device is able to be set, but not the intensity of the radiation generated in the activated state. This advantageously has the result that, for shorter target working distances, lower intensities of the generated radiation may be set for comparatively larger working distances, whereby the risk of overexposure at short working distances and of underexposures at comparatively larger working distances are minimized, which ensures reliable and therefore also accurate pose detection.

In a further exemplary embodiment, the microscopy system includes multiple groups of tracking illumination devices, wherein a group includes at least one, but typically more than one tracking illumination device. By way of example, a group may include what is known as an array of tracking illumination devices. The microscopy system furthermore includes at least two optical elements for beam guidance that are assigned to different groups. This may mean that the radiation generated by the one or more tracking illumination devices of this group is guided by the optical element assigned to the group. By way of example, a first optical element may be assigned to a first group and a further optical element may be assigned to a further group of tracking illumination devices. In this case, at least one tracking illumination device of one group may not be part of another group. Typically, none of the tracking illumination devices of one group is part of another group of tracking illumination devices. It is possible for an optical element to be assigned to multiple groups of tracking illumination devices. In this case, the various optical elements for beam guidance differ in terms of at least one assigned group of tracking illumination devices.

It is possible for the various illumination devices of a group to be arranged in a row along a common straight line or in a matrix-like manner. In this case, each of the illumination devices of a group may be actuated individually, for example to set an activation state and/or an intensity of the generated radiation. Furthermore, it is possible for the illumination devices to be arranged on a thermally conductive carrier, which is thermally connected to a cooling device for improved heat dissipation.

This advantageously has the result that an illumination region may be set in a simple manner depending on working distance. The (different) optical properties of the optical elements thus make it possible to define different illumination regions, wherein the correspondingly defined illumination region is illuminated upon activation of the tracking illumination devices of the group assigned to the optical element. Mutually different illumination regions may differ in terms of pose, shape, size, or in terms of another property. Adapting the illumination region to the working distance advantageously further reduces the risk of underexposure or overexposure. It is likewise advantageously possible to avoid unnecessary illumination of regions that are not of interest to the pose detection, which on the one hand advantageously reduces an energy requirement for the pose detection and on the other hand advantageously reduces unwanted stray light, which may affect the operation of further systems.

In a further exemplary embodiment, at least two of the plurality of optical elements for beam guidance have differing optical properties. The optical properties may be selected such that the optical elements, upon activation of one or more groups, set differing illumination regions, in particular in a sectional plane perpendicular to the optical axis of at least one element. This advantageously has the result of enabling an easily achievable adaptation of the illumination region to the working distance, in particular via built-in, static optical elements, which allows an adaptation without any complicated change of optical properties. Of course, however, it is also possible for the different optical elements to have the same optical properties.

In a further exemplary embodiment, the illumination angle of the illumination region defined by the optical properties of a first optical element is larger than the illumination angle of the illumination region defined by the optical properties of a further optical element. If the first optical element is assigned to a first group of tracking illumination devices, then these may be activated when a first working distance is determined, wherein the first working distance is less than a further working distance, wherein, when the further working distance is determined, the tracking illumination devices of a further group, to which the further optical element is assigned, are activated. In other words, a larger illumination angle of the illumination region may thus be set for comparatively shorter working distances, thereby on the one hand resulting in adaptation of the illumination angles to the capture angles, but on the other hand unwanted light scattering may also be reduced. In particular, the illumination angles of the working distance-dependent illumination regions may correspond equally to the capture angles in the working distance-specific capture regions or be larger than these by at most a predetermined degree.

In a further exemplary embodiment, the optical axes of the optical elements for beam guidance intersect at a common point. Advantageously, this results in the creation of an illumination region by the activation of a plurality of groups whose radiations effectively superimpose to form resultant radiation. However, it is also possible that optical axes of the illumination devices are oriented or arranged differently from one another and do not intersect at a common point.

In a further exemplary embodiment, the tracking illumination devices are operated in pulsed fashion, in particular with a predetermined duty cycle. In this case, a tracking illumination device may be activated for a predetermined duration and deactivated for a predetermined further duration, with the sum of the durations equaling a period duration. Furthermore, the duration of an activated state (and hence also the mentioned duty cycle) is adapted to an exposure period of the tracking camera. In this case, the exposure duration may be determined by a superordinate system, for example by a camera control device. This camera control device may likewise be a constituent part of the microscopy system and, for example, be signal-connected to the control device. This advantageously results in the above-described stray light generation being further reduced, especially since there is also no illumination in portions of time in which no image is generated for pose detection purposes. This likewise reduces the energy requirement of the microscopy system.

In a further exemplary embodiment, the microscopy system includes a computing device for determining the working distance. This computing device may be formed as a microcontroller or an integrated circuit or include such a microcontroller or integrated circuit. In particular, the computing device may be formed by a control device of the microscopy system or be a part thereof.

In a further exemplary embodiment, the microscopy system includes a beam path for generating the microscopic image or forms same. This beam path may be the beam path of an objective of the microscope and/or be formed by the microscope body. The microscopic image representation in this case refers to the magnified image representation of an examination region. Furthermore, the microscopy system includes or forms at least one further beam path for generating the tracking image representation, with the beam paths differing from one another. The beam path may be the beam path of an objective system of the tracking camera and/or be formed by the microscope body. For example, the various beam paths may be separated from one another by wall elements and/or web elements. These elements may be formed by the microscope body.

Additionally, the microscopy system may include optical elements which are arranged in or on the respective beam path and serve to generate the image representations. Optical elements arranged in different beam paths may differ from one another.

It is possible that a component with the movable optical element and/or the tracking illumination device or devices, and the optical elements for beam guidance to be detachably fastened to the microscope body. In other words, it is thus possible to retrofit a pose detection functionality. The component may also include the control device. In this case, appropriate signal lines and connections should then be established for power supply purposes between the component and the microscopy system. However, it is also possible that the abovementioned component parts of the component or at least some of these are integrated in the microscope body. This results in a space-saving provision of a reliable and accurate pose detection, with, however, a high-quality magnification likewise being ensured since the different beam paths mean that the microscopic imaging or the tracking imaging is not influenced.

In a further exemplary embodiment, the microscopy system includes at least one field of view illumination device. In this case, the field of view illumination device may likewise be arranged in or on the microscope body. Additionally, the field of view illumination device differs from the tracking illumination device or devices. In particular, an illumination region of the field of view illumination device may be larger than the largest illumination region able to be set for the tracking illumination device or devices. Furthermore, the field of view illumination device can generate radiation at wavelengths from a wavelength range that differs from the wavelengths from the wavelength range of the radiation of the tracking illumination devices. In particular, the wavelength ranges may not intersect or only intersect in a partial region.

As a result, this results advantageously in the illumination for detecting the pose being able to be set independently of the illumination for microscopic imaging, thereby improving an operating quality for a user of the microscopy system.

In a further exemplary embodiment, exactly two poses of the movable optical element can be set repeatably, which is to say with a predetermined repetition accuracy. The repetition accuracy represents the size of a maximum pose deviation which sets in for the multiple movement of the optical element into a specific pose. This repetition accuracy may be determined for example as a standard deviation of the pose deviations for a plurality of, for example for more than 100, repeated positioning operations into the pose. Typically, the repetition accuracy is less than or equal to 1 μm or 1°. In other words, a microscopy system configured thus may therefore repeatably set two capture regions. This advantageously yields a mechanically simple design of the microscopy system, with however a reliable and accurate pose capture being enabled at the same time.

In a further exemplary embodiment, the movable optical element is movably mounted, typically linearly movably mounted, between the two end stop elements, with a first end stop element having or forming a first bearing element for static support and a further end stop element having or forming a further bearing element for static support, with the bearing elements repeatably defining the stop poses of the optical element. Further, the repetition accuracy of a movement pose of the optical element may be less than the repetition accuracy in a stop pose. The movement pose may be a pose between the two stop poses. The repetition accuracy of a movement pose may represent the extent of a maximum deviation between the actual movement poses that occur for the multiple movement of the carrier into a predetermined movement pose, wherein the carrier is mounted during these movements by a movement bearing element, which is to say the movement bearing element guides the movement of the carrier. The movement pose thus denotes a position and/or orientation of the carrier between the stop poses which may be set by a movement of the carrier that is mounted or guided by the movement bearing element. In other words, the movement bearing element is configured such that, when moving the carrier multiple times into a movement pose, only a repetition accuracy that is lower than the repetition accuracy when moving the carrier multiple times into the stop pose is achievable. The carrier may be moved out of a movement pose into a first stop pose and into a further stop pose, which is to say such a movement is permitted. The carrier may be moved out of the first or further stop pose into a movement pose or into the remaining stop pose. The accuracy being lower may mean that the value of the repetition accuracy is larger than the value of the repetition accuracy in a stop pose, for example ten times larger. In other words, a movement pose of the optical element is not defined repeatably by the movement bearing element in the same way as a stop pose is by the first and the further bearing element. This results advantageously in a simple and cost-effective design of the optical system, in particular since there is no need for highly precise manufacturing of the movement bearing element and optionally of the guiding elements provided by said element.

A method for operating a microscopy system is also provided. In this case, the microscopy system may be formed in accordance with any of the embodiments described in this disclosure. The method includes:
determining a working distance,
setting a pose of the movable optical element based on the working distance, and/or
setting an operating mode of the tracking illumination devices and/or setting an illumination region of the tracking illumination devices based on the working distance.

Furthermore, the pose of the movable optical element set in this way and/or the operating mode set in this way and/or of the illumination region of the tracking illumination devices may be used to perform a pose detection by generating an image representation of the at least one marker, with this image representation then being evaluated for pose determination purposes. The provided microscopy system and method advantageously allows the integration of essential elements for pose detection into the microscopy system, in particular a surgical microscope. Furthermore, there is no need for any marker arranged on the microscopy system for detection by a microscopy-external pose detection system. Setting the capture region likewise advantageously has the result of creating the possibility to having to evaluate only small evaluation regions on the image sensor, which, on the one hand, reduces the required computing power and, on the other hand, also increases accuracy of the detection of markers.

### BRIEF DESCRIPTION OF THE DRAWINGS

The disclosure will now be described with reference to the drawings wherein:

FIG. 1 shows a schematic view of a microscopy system according to an exemplary embodiment of the disclosure,

FIG. 2 shows a perspective schematic view of a microscope,

FIG. 3 shows a schematic sub-view of a microscope,

FIG. 4 shows a schematic block diagram of a microscopy system according to a further exemplary embodiment the disclosure,

FIG. 5 shows a schematic block diagram of a microscopy system according to the disclosure in a further embodiment,

FIG. 6 shows a schematic block diagram of a microscopy system according to a further exemplary embodiment of the disclosure,

FIG. 7A shows a schematic view of a set first capture region,

FIG. 7B shows a schematic view of a set further capture region,

FIG. 8A shows a schematic view of a set first illumination region,

FIG. 8B shows a schematic view of a further set illumination region,

FIG. 9A shows a schematic flowchart of a method according a first exemplary embodiment of the disclosure,

FIG. 9B shows a schematic flowchart of a method according to a further exemplary embodiment of the disclosure, and

FIG. 9C shows a schematic flowchart of a method according to a further exemplary embodiment of the disclosure.

### DESCRIPTION OF EXEMPLARY EMBODIMENTS

Identical reference signs hereinafter denote elements having identical or similar technical features.

FIG. 1 illustrates a microscopy system 1 according to the an exemplary embodiment of disclosure during use in an operating environment. The microscopy system 1 includes a surgical microscope 2, which is arranged on a stand 3 for mounting the microscope 2, in particular at a free end of the stand 3. The stand 3 allows a movement of the microscope for changing the pose, which is to say the position and/or orientation, of the microscope 2. The stand 3 shown is an exemplary kinematic structure for holding and moving the microscope 2. A person skilled in the art will of course know that other kinematic structures may also be used.

Drive devices (not depicted) of the stand 3 may enable a rotational movement of movable parts of the stand 3 about axes of rotation 4, 5, 6. FIG. 1 also illustrates a control device 7 that serves to control the drive devices. By way of the control device 7, the drive devices can be driven in particular such that the microscope 2 implements a desired movement, in particular in the reference coordinate system. Moreover, the control device 7 may also serve to set operating parameters and/or movement parameters of the microscope 2, for example to set a zoom of the microscope 2. To this end, the control device 7 may be signal-connected and/or data-connected to the microscope 2 and/or to the drive devices. Also illustrated is a patient 13 lying on an operating table 14. Also illustrated is that the microscope 2 includes an eyepiece 15 into which the user 8 looks to view, through the microscope 2, a partial region of the patient 13, in particular with magnification. Also illustrated is an optical axis 17 of the microscope 2.

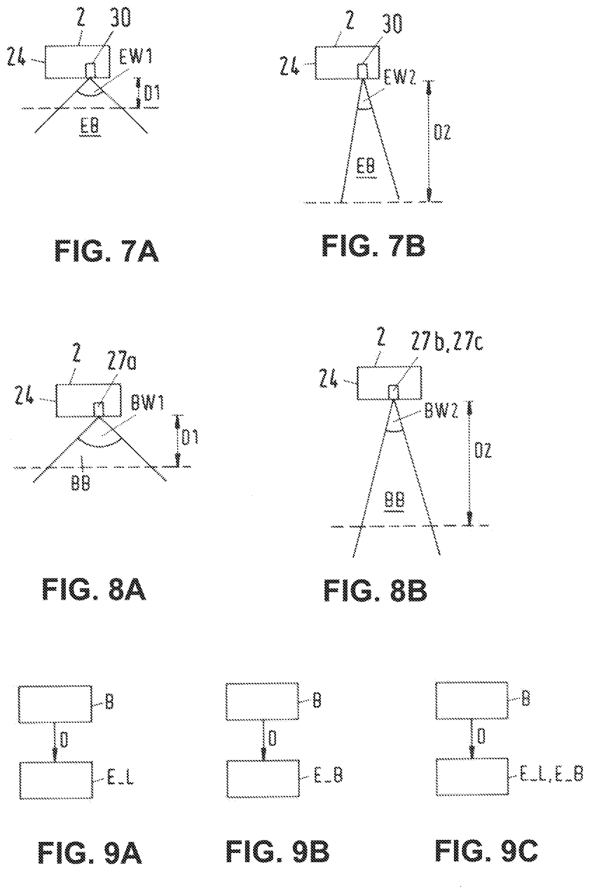

The microscopy system 1 moreover includes a pose detection device for detecting a pose of an instrument 19 that can be held and moved by a user 8. The user 8 may be a surgeon, for example. The pose detection device includes at least one target 9 with at least one marker element and at least one tracking camera 30 for capturing the target 9. A pose of the target 9 may be determined with the pose detection device. FIG. 1 illustrates that the target 9 is fastened to the instrument 19, with it then also being possible to determine the pose of the instrument 19 on account of the fixed arrangement of the target 9 on the instrument 19. The tracking camera 30 is arranged in a microscope body 24 of the microscope 2, in particular in a housing of the microscope body 24. A capture region EB (see FIG. 7A) of the tracking camera 30 in this case at least partially overlaps with a capture region of the microscope 2 for the magnified depiction of the patient or regions of the body of the patient 13.

Also illustrated is a signal-connection and/or data-connection 12 between the tracking camera 30 and the control device 7. By way of the control device 7 or by way of an evaluation device (not illustrated), which may be part of the pose detection device for example, it is possible to determine a relative pose between target 9 and tracking camera 30 in a three-dimensional coordinate system of the pose detection device. By way of example, it is thus possible to determine the pose of the target 9 in a two-dimensional image coordinate system of the tracking camera 30 and then, based on this pose, a pose in the coordinate system of the pose detection device. In this case, both a position and an orientation may be determined in the three-dimensional coordinate system of the pose detection device. This pose may then be converted into the reference coordinate system by way of a known transformation, for example a transformation determined by a registration. The pose of the target 9 may be determined by evaluating exactly one two-dimensional image representation of the tracking camera 30.

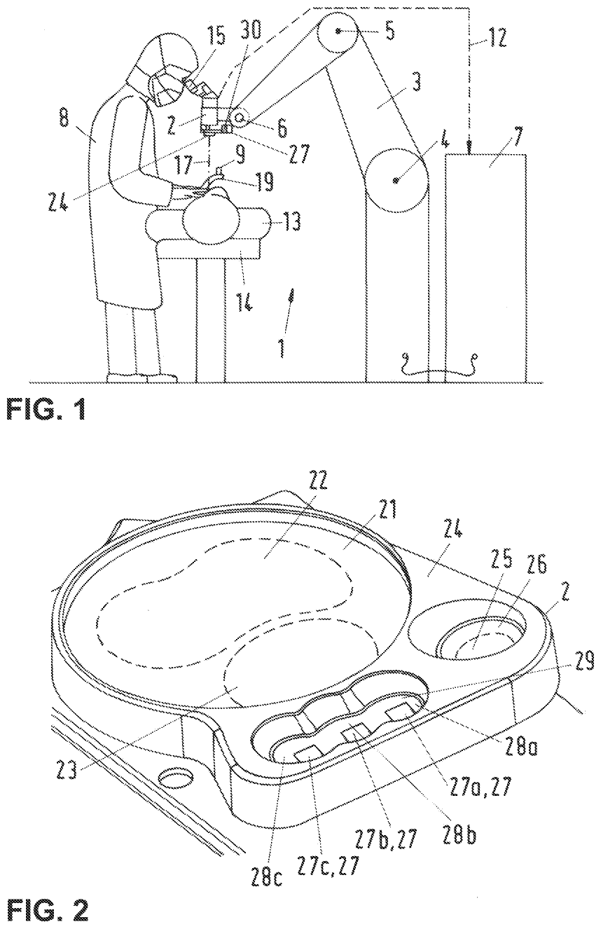

FIG. 2 shows a schematic perspective illustration of a section of the microscope 2. A terminating glass 21 of the microscope 2 is illustrated; it is arranged between a beam path 22 for generating the microscopic image representation and an outside region, for example the room with the patient 13. The terminating glass 21 is transparent here to radiation, at least in the visible wavelength range, but protects the beam path 22 for generating the microscopic image representation from contamination. Also illustrated is a field of view illumination device 23 which, just like the beam path 22, is integrated in a microscope body 24 of the microscope 2. In this case, the terminating glass 21 covers both the beam path 22 and the field of view illumination device 23.

Also illustrated is a beam path 25 for generating the tracking image representation. This beam path 25 is likewise formed by the microscope body 24 but differs from the beam path 22 for generating the microscopic image representation; in particular, it is separated by wall elements. Also illustrated is a terminating glass 26 that is arranged between the beam path 25 and the external environment. The terminating glass 26 is transparent to light, at least in the near-infrared region, and may differ from the terminating glass 21.

Also illustrated are tracking illumination devices 27a, 27b, 27c, which are likewise integrated in the microscope body 24 of the microscope 2. The tracking illumination devices 27a, 27b, 27c are different here from the field of view illumination device 23. The tracking illumination devices 27a, 27b, 27c generate light here in the near-infrared region. Lens elements 28a, 28b, 28c are arranged between the tracking illumination devices 27a, 27b, 27c and the external environment. The lens elements 28a, 28b, 28c have differing optical properties, in particular differing focal lengths. In this case, a first lens element 28a is assigned to the first tracking illumination device 27a, a second lens element 28b is assigned to a second tracking illumination device 27b and a third lens element 28c is assigned to a third tracking illumination device 27c. This may mean that the radiation generated by the tracking illumination device 27a, 27b, 27c is radiated by the lens element 28a, 28b, 28c assigned to this tracking illumination device 27a, 27b, 27c. FIG. 2 illustrates that the lens elements 28a, 28b, 28c are formed by a lens composite element 29, wherein this lens composite element 29 includes different sections that form the lens elements 28a, 28b, 28c.

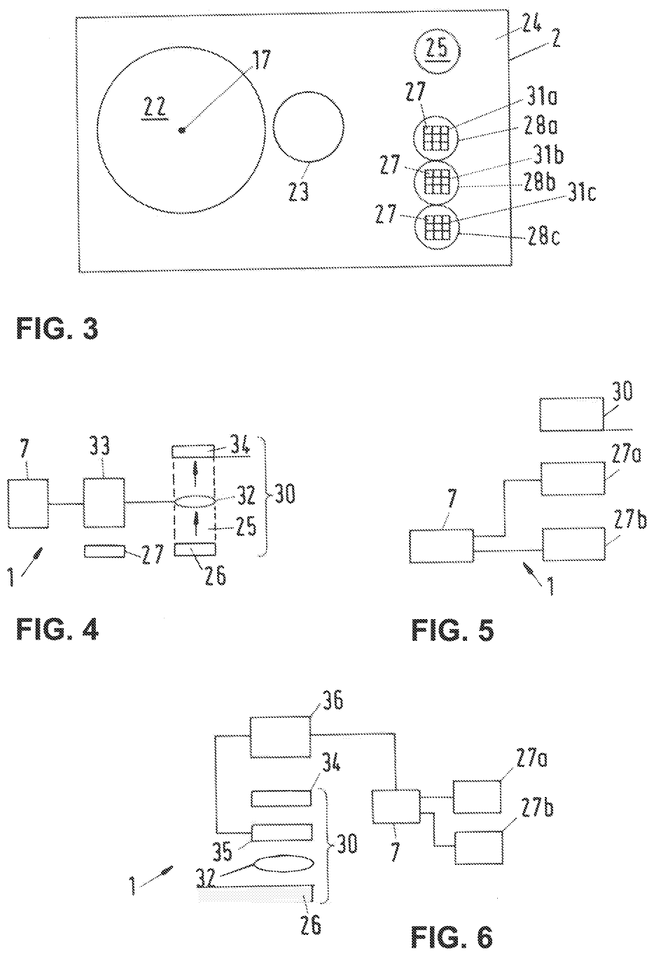

FIG. 3 shows a schematic sub-view of a microscope 2, in particular of a microscope body 24. The explained beam path 22 for generating the microscopic image representation and the beam path 25, likewise explained in connection with FIG. 2, for generating the tracking image representation by way of a tracking camera 30 (see FIG. 4) are illustrated. The field of view illumination device 23 is likewise illustrated. Also illustrated are three differing lens elements 28a, 28b, 28c, which, unlike the embodiment illustrated in FIG. 2, are not formed by a common lens composite element. It is illustrated that the microscopy system 1 (see FIG. 1) includes three groups 31a, 31b, 31c of tracking illumination devices 27, wherein, for the sake of clarity, only one tracking illumination device 27 of each group 31a, 31b, 31c is provided with a reference sign. The tracking illumination devices 27 may be formed here as LEDs or include same. It is illustrated that the groups 31a, 31b, 31c include what are known as LED arrays, wherein each of the tracking illumination devices 27 of each group 31a, 31b, 31c may be driven individually, for example to activate them individually or to set the intensity of the radiation generated by the tracking illumination device 27. The different lens elements 28a, 28b, 28c are assigned here to the different groups 31a, 31b, 31c. Thus, the first lens element 28a is assigned to the first group 31a, the second lens element 28b is assigned to the second group 31b and the third lens element 28c is assigned to the third group 31c, wherein the radiation generated by the tracking illumination devices 27 of one group 31a, 31b, 31c is radiated by the lens element 28a, 28b, 28c assigned to the respective group and is guided and/or shaped thereby.

FIG. 4 shows a schematic block diagram of a microscopy system 1 according to a further exemplary embodiment of the disclosure. The microscopy system 1 includes a control device or controller 7 that serves to control a movable optical element 32, which is in the form of a lens. To this end, the control device 7 may be connected, via a signal connection, to a drive device 33 for generating a drive force that causes the movement. What is illustrated here is that the optical element 32 may be moved with a translational movement in a beam path 25 for generating the tracking image representation, in particular moved parallel to a mid-axis of the beam path. In this case, it is conceivable that the optical element 32 can be moved between two end stops, in particular with a linear movement. It is also illustrated that the microscopy system 1 includes a tracking camera 30, which includes the optical element 32, the terminating glass 26, and also an image sensor 34 for generating an in particular two-dimensional image representation. The movement of the movable optical element 32 allows a capture region EB (see FIG. 7B, for example) of the tracking camera 30 to be modified, in particular a capture angle EW1, EW2 of the capture region EB. It is also possible that the microscopy system 1 illustrated in FIG. 4 includes one or more tracking illumination devices 27. Operation of the tracking illumination device 27 may be controllable by the control device 7, in particular in terms of an activation state and/or an intensity of the radiation generated by the tracking illumination device 27 in the activated state.

FIG. 5 shows a schematic block diagram of a microscopy system 1 according to a further exemplary embodiment of the disclosure. The microscopy system 1 includes a control device 7 and a tracking camera 30 for pose detection of at least one marker, which may be a component part of the target 9 illustrated in FIG. 1. It is possible that the microscopy system 1 illustrated in FIG. 5 includes a tracking camera 30 with a movable optical element 32 (see FIG. 4), the pose of which may be changed to set a capture region EB (see FIG. 7B) of the tracking camera 30. However, this is not mandatory. The microscopy system 1 illustrated in FIG. 5 may thus also include a tracking camera 30 with a fixed focal length objective, that is to say without a movable optical element 32 for setting a capture region EB. FIG. 5 illustrates that the control device 7 is connected, via a signal connection, to two tracking illumination devices 27a, 27b. In this case, the control device 7 or the signal connection of these tracking illumination devices 27a, 27b may control in particular the activation state of each of the two tracking illumination devices 27a, 27b and/or the intensity of the radiation generated by each of the tracking illumination devices 27a, 27b in the activated state.

FIG. 6 shows a schematic block diagram of a microscopy system 1 according to a further exemplary embodiment of the disclosure. What is illustrated is a control device 7 of the microscopy system 1, which controls an operating mode of the tracking illumination devices 27a, 27b according to the operation of the exemplary embodiment illustrated in FIG. 5. Furthermore, the microscopy system 1 includes a tracking camera 30 having an image sensor 34, a terminating glass 26 and a controllable aperture 35. It is furthermore illustrated that the microscopy system 1 includes a camera control device 36 that controls an exposure duration of the image sensor 34 by setting states of the aperture 35. This camera control device 36 is connected to the control device 7 via a signal connection. This signal connection may be used to transmit information as to the periods in which exposure of the image sensor 34 takes place and the period in which no exposure takes place. The control device 7 may then control the operating mode of the tracking illumination device 27a, 27b such that these are operated in pulsed fashion, wherein the tracking illumination devices 27a, 27b are activated only in periods of time (and thus generate radiation) in which the aperture 35 is in the open state and the image sensor 34 is exposed. It is furthermore illustrated that the tracking camera 30 includes a movable optical element 32, as in the exemplary embodiment illustrated in FIG. 4. However, this is not absolutely necessary for the exemplary embodiment illustrated in FIG. 6, since the tracking camera 30 may also include a fixed focal length objective.

FIG. 7A shows a schematic illustration of a capture region EB of the tracking camera 30 for a first working distance D1. The working distance D1 in this case denotes a distance along an optical axis 17 of the microscope 2 between a reference plane or plane of focus, illustrated in dashed form, and the terminating glass 21, illustrated for example in FIG. 1, of the microscope 2. Also illustrated is a capture angle EW1 of the tracking camera 30, which is determined for a first working distance D1. FIG. 7B illustrates a second working distance D2, which is larger than the first working distance D1 illustrated in FIG. 7A. Likewise illustrated is a further capture angle EW2, which is set for the further working distance D2. Looking at FIG. 7A and FIG. 7B together, it is apparent that the further capture angle EW2 of the tracking camera 30 is smaller than the first capture angle EW2 when the further working distance D2 is larger than the first working distance D1. The different capture angles EW1, EW2 may be set by setting different poses of the movable optical element 32 of the tracking camera 30.

FIG. 8A shows a schematic view of an illumination region BB at a first working distance D1, and FIG. 8B shows a schematic view of an illumination region BB at a second working distance D2. It is illustrated that an illumination angle BW2 that is set for the second working distance D2 is smaller than an illumination angle BW1 that is set for the first working distance D1. It is also illustrated that, at the first working distance D1, only a first tracking illumination device 27a or a first group of tracking illumination devices 27 (not illustrated) is activated. At the second working distance D2, the first tracking illumination device 27a is deactivated and the tracking illumination devices 27b, 27c are activated. Also, a second and a third group 31b, 31c of tracking illumination devices 27 may be activated, wherein the first group 31a of tracking illumination devices 27 is deactivated.

FIG. 9A, FIG. 9B, and FIG. 9C show schematic flowcharts of a method according to different exemplary embodiments of the disclosure. In the method illustrated in FIG. 9A, a working distance D is determined B. After the working distance D has been determined, a pose of the movable optical element 32 of a microscopy system 1 is set E (see FIG. 4) based on the working distance D. This pose setting leads to the detection angle EW1, EW2 being set (see FIG. 7A and FIG. 7B). In the method illustrated in FIG. 9A, a working distance D is likewise determined B. Then, an operating mode and/or an illumination region BB (see FIG. 8A) of the tracking illumination devices 27, 27a, 27b, 27c (see for example FIG. 1 and FIG. 2) are set E_B. In the method illustrated in FIG. 9C, a working distance D is likewise determined B. Then, a pose of the movable optical element 32 of a microscopy system 1 is set E_L and an operating mode and/or an illumination region BB of the tracking illumination device 27, 27a, 27b, 27c are/is set E_B based on the working distance D.

### LIST OF REFERENCE NUMERALS

1 Microscopy system
2 Microscope
3 Stand
4, 5, 6 Axes of rotation
7 Control device
8 User
9 Target
12 Signal connection
13 Patient
14 Operating table
15 Eyepiece
17 Optical axis
19 Instrument
21 Terminating glass
22 Beam path for microscopic imaging
23 Field of view illumination device
24 Microscope body
25 Beam path for the tracking image representation generation
26 Terminating glass
27, 27a, 27b, 27c Tracking illumination device
28a, 28b, 28c Lens element
29 Lens composite element
30 Tracking camera
31a, 31a, 31b Group
32 Movable optical element
33 Drive device
34 Image sensor
35 Aperture
36 Camera control device
EB Capture region
BB Illumination region
D, D1, D2 Working distance
EW1, EW2 Capture angle
BW1, BW2 Illumination angle
B Determination
E_L Setting of the pose
E_B Setting of the illumination region and/or operating mode

What is claimed is:

1. A microscopy system, comprising:
a microscope having a settable working distance of the microscope and at least one tracking camera for pose detection of at least one marker at a working distance of the tracking camera;
at least one device configured to determine the working distance of the microscope;
at least one movable optical element, the pose of which can be changed to set a capture region of the tracking camera; and
at least one controller configured to control the movable optical element, in which the pose of the movable optical element is set, based on the working distance of the microscope.

2. The microscopy system as claimed in claim 1, wherein a first capture angle of the tracking camera is set for a first working distance of the microscope and a further capture angle of the tracking camera is set for at least one further working distance of the microscope, with the first working distance of the microscope being less than the further working distance of the microscope and the first capture angle being larger than the further capture angle.

3. The microscopy system as claimed in claim 1, wherein exactly two poses of the movable optical element can be set repeatably.

4. The microscopy system as claimed in claim 3, wherein the movable optical element is movably mounted between two end stop elements, with a first end stop element having or forming a first bearing element for static support and a further end stop element having or forming a further bearing element for static support, and with the bearing elements repeatably defining the stop poses of the optical element.

5. A microscopy system, comprising:
a microscope having a settable working distance of the microscope and at least one tracking camera for pose detection of at least one marker at a working distance of the tracking camera;
at least one device configured to determine the working distance of the microscope;
at least two tracking illumination devices and at least one optical element for beam guidance of the radiation generated by the tracking illumination devices; and
at least one controller configured to control the tracking illumination devices, in which an operating mode and/or an illumination region of the tracking illumination devices is set based on the working distance of the microscope.

6. The microscopy system as claimed in claim 5, wherein a plurality of the activated tracking illumination devices and/or an intensity of the radiation generated by the activated tracking illumination devices can be set based on the working distance of the microscope.

7. The microscopy system as claimed in claim 6, wherein a first overall intensity of the radiation generated by the tracking illumination devices is set for a first working distance of the microscope, and a further overall intensity of the radiation generated by the tracking illumination devices is set for a further working distance of the microscope, the first working distance of the microscope being less than the further working distance of the microscope and the first overall intensity being lower than the further overall intensity.

8. The microscopy system as claimed in claim 5, further comprising:
a plurality of groups of tracking illumination devices, with one group including at least one tracking illumination device; and
at least two optical elements for beam guidance that are assigned to different groups.

9. The microscopy system as claimed in claim 8, wherein at least two of the plurality of optical elements for beam guidance have differing optical properties.

10. The microscopy system as claimed in claim 9, wherein an illumination angle of an illumination region defined by the optical properties of a first optical element is less than the illumination angle of the illumination region defined by the optical properties of a further optical element.

11. The microscopy system as claimed in claim 5, wherein optical axes of the optical elements for beam guidance intersect at a common point.

12. The microscopy system as claimed in claim 5, wherein the tracking illumination devices are operated in pulsed fashion, with the duration of an activated state being adapted to an exposure duration of the tracking camera.

13. The microscopy system as claimed in claim 5, further comprising:
at least one field of view illumination device, wherein the field of view illumination device is different from the tracking illumination devices.

14. The microscopy system as claimed in claim 1, further comprising a computing device configured to determine the working distance of the microscope.

15. The microscopy system as claimed in claim 1, further comprising or forming:
a beam path for generating the microscopic image representation; and
at least one further beam path for generating the tracking image representation, the beam paths being different from one another.

16. A method for operating a microscopy system as claimed in claim 1, the method comprising:
determining a working distance of the microscope; and
setting a pose of the movable optical element based on the working distance of the microscope.

17. A method for operating a microscopy system as claimed in claim 5, the method comprising:
determining a working distance of the microscope; and
setting an operating mode and/or an illumination region of the tracking illumination devices based on the working distance of the microscope.
